(19) United States
(12) Patent Application Publication
(10) Pub. No.: US 2026/0273567 A1
(43) Pub. Date: Sep. 17, 2026

(54) PAINT MIST REMOVAL DEVICE

(71) Applicant: TRINITY INDUSTRIAL CORPORATION, Aichi (JP)

(72) Inventors: Masahiro HARADA, Aichi (JP); Ryota SAITO, Aichi (JP)

(73) Assignee: TRINITY INDUSTRIAL CORPORATION, Aichi (JP)

(21) Appl. No.: 19/472,343

(22) PCT Filed: Feb. 23, 2024
(86) PCT No.: PCT/JP2024/006677

§ 371 Date: Dec. 16, 2025

(30) Foreign Application Priority Data
Apr. 6, 2023 (JP) 2023-061879

(51) Int. Cl. B05B 14/43; B01D 46/00; B01D 46/121

(52) U.S. Cl. CPC B05B 14/43; B01D 46/0005; B01D 46/121

(57) ABSTRACT

A paint mist removal device with easily replaced filters includes a filter housing body having a lower housing section and an upper housing section. The lower housing section is configured to removably accommodate a primary filter, and the upper housing section is configured to removably accommodate a secondary filter. The primary filter takes in booth air from a side surface and discharges the booth air from an upper surface. The secondary filter is disposed adjacent to an upper side of the lower housing section and arranged in a triangular configuration. An inlet for introducing booth air into the primary filter in the lower housing section is provided on a side surface of the filter housing body, and an outlet for discharging booth air from the secondary filter in the upper housing section is provided in the filter housing body at a position higher than the inlet.

### TECHNICAL FIELD

The present invention relates to a paint mist removal device that removes paint mist contained in booth air discharged from a coating booth.

### BACKGROUND ART

Conventionally, coating equipment for coating an object to be coated, such as a vehicle body, has been known. For example, as shown in FIG. 17, in coating equipment 131, it has been proposed to install a paint mist removal device 134 in a booth underfloor space 133 of a coating booth 132 (see, for example, Patent Document 1). The paint mist removal device 134 includes a filter housing body 137 capable of accommodating a primary filter 135 and a secondary filter 136, and removes paint mist contained in booth air A1 discharged from a booth space 138 of the coating booth 132. The primary filter 135 takes in the booth air Al from above (on the side of the booth space 138) and discharges it laterally (to the right in FIG. 17). A secondary filter 136 is disposed adjacent to the side of the primary filter 135.

### PRIOR ART DOCUMENTS

### Patent Document

Patent Document 1: Japanese Unexamined Patent Application Publication No. 2021-133269

### DISCLOSURE OF THE INVENTION

### Problems to be Solved by the Invention

In FIG. 17, an exhaust duct 139 for discharging booth air Al to the outside of the coating equipment 131 is provided on the side of the secondary filter 136 (to the right in FIG. 17). In this case, an operator can access the paint mist removal device 134 only from the side where no exhaust duct 139 is provided (to the left in FIG. 17). Therefore, when replacing the secondary filter 136, it is necessary to remove the primary filter 135 from the paint mist removal device 134 before taking out the secondary filter 136. Thus, there is a problem in that the replacement work of the filters becomes troublesome.

The present invention has been made in view of the above problem, and an object thereof is to provide a paint mist removal device that allows easy replacement of filters.

### Means for Solving the Problems

To solve the above problem, a first aspect of the present invention refers to a paint mist removal device that removes paint mist contained in booth air discharged from a paint booth by passing the booth air through a plurality of filters, comprising: a filter housing body including: a lower housing section configured to allow insertion and removal of a primary filter that is formed into a box shape mainly from a combustible material and that takes in the booth air from a side surface and discharges the booth air from an upper surface; and an upper housing section disposed adjacent to an upper side of the lower housing section and configured to allow insertion and removal of a plurality of secondary filters arranged in an inverted V-shaped configuration; wherein an inlet for introducing the booth air into the primary filter in the lower housing section is provided on a side surface of the filter housing body, and an outlet for discharging the booth air from the secondary filters in the upper housing section is provided, in the filter housing body, at a position higher than the inlet.

According to the first aspect of the present invention, the upper housing section is disposed adjacent to an upper side of the lower housing section. Therefore, even when another structure is disposed adjacent to a side of the filter housing body, either the primary filter or the secondary filter can be replaced without being obstructed by the other filter or by the adjacent structure. In addition, since the upper housing section is disposed adjacent to the upper side of the lower housing section, the installation area of the filter housing body (the paint mist removal device) is reduced, thereby increasing the degree of freedom in installing the paint mist removal device.

Furthermore, in the first aspect of the present invention, the primary filter is removably accommodated in the lower housing section, and the secondary filter is removably accommodated in the upper housing section. Accordingly, since the operator can clean the inside of the filter housing body with both the primary and secondary filters removed, the workability in cleaning the filter housing body is improved.

Moreover, in the first aspect of the present invention, an outlet is provided at a position higher than the inlet in the filter housing body. Therefore, when, for example, an exhaust duct is connected to the outlet of the filter housing body, the exhaust duct is positioned above the filter housing body, so that it does not interfere with the operator.

In the first aspect of the present invention, since the primary filter is formed mainly of a combustible material, the primary filter can be incinerated or replaced as a disposable component. Examples of the combustible material include paper, resin, and wood. In addition, when corrugated cardboard or plastic cardboard is used as the combustible material, the strength of the primary filter is improved.

The second aspect of the present invention refers to the paint mist removal device according to the first aspect of the present invention, wherein a holding-down member configured to come into contact with an upper surface of the primary filter is provided on an upper portion of an inner surface of the lower housing section.

According to the second aspect of the present invention, an inlet is provided on a side surface of the filter housing body, and an outlet is provided at a position higher than the inlet in the filter housing body. Therefore, after the booth air is taken into the primary filter from the side of the filter housing body, it is discharged from the outlet located above the inlet. At this time, since a force acts upward on an upper portion of the primary filter due to the airflow pressure of the booth air passing through the primary filter, there is a possibility that the primary filter may be lifted upward. In the second aspect of the present invention, since the holding member is brought into contact with the upper surface of the primary filter, it is possible to prevent the primary filter from being lifted.

The third aspect of the present invention refers to the paint mist removal device according to the second aspect of the present invention, wherein the primary filter includes a filter body having an inlet on a side surface and an outlet on an upper surface, and an upper lid portion that covers the upper surface of the filter body except for the outlet, and wherein the holding member is provided at a position where it can come into contact with an upper surface of the upper lid portion.

According to the third aspect of the present invention, after the booth air is taken into the primary filter from a side portion of the filter housing body, the booth air is discharged from the outlet located above the inlet. At this time, since airflow pressure acts upward on the upper lid portion that constitutes the primary filter, there is a possibility that the upper lid portion may be lifted, allowing the booth air (paint mist) to leak therefrom, which may reduce the dust collection efficiency of the primary filter. In the third aspect of the present invention, since the holding member is brought into contact with the upper surface of the upper lid portion, it is possible to prevent the upper lid portion from being lifted, so that a reduction in the dust collection efficiency of the primary filter can be prevented.

The fourth aspect of the present invention refers to the paint mist removal device according to the third aspect of the present invention, wherein the holding member is provided detachably with respect to the lower housing section.

According to the fourth aspect of the present invention, since the holding member is detachable and can be removed during cleaning of the inside of the filter housing body, the workability of cleaning the filter housing body is improved.

The fifth aspect of the present invention refers to the paint mist removal device according to the fourth aspect of the present invention, wherein an inner surface of a side wall of the filter housing body in which the inlet is provided is in surface contact with an air intake surface of the primary filter accommodated in the lower housing section.

According to the fifth aspect of the present invention, since the inner surface of the side wall in which the inlet is provided is in surface contact with the air intake surface of the primary filter, a gap is less likely to be formed between them. Therefore, it is possible to prevent the paint mist from entering between the inner surface of the side wall and the air intake surface of the primary filter.

The sixth aspect of the present invention refers to the paint mist removal device according to the fourth aspect of the present invention, wherein a rib projecting toward the primary filter accommodated in the lower housing section is provided on an inner surface of a side wall of the filter housing body in which the inlet is provided, so as to surround the inlet.

According to the sixth aspect of the present invention, since the gap formed between the side wall in which the inlet is provided and the primary filter can be closed by the rib, it is possible to prevent the paint mist from entering the gap.

The seventh aspect of the present invention refers to the paint mist removal device according to the fourth aspect of the present invention, wherein a guide member projecting from an inner surface of the lower housing section and extending along an insertion/removal direction of the primary filter is provided.

According to the seventh aspect of the present invention, when the primary filter is accommodated in the lower housing section, the position of the primary filter is guided by the guide member, thereby facilitating alignment of the inlet of the primary filter with the inlet of the filter housing body.

### Effects of the Invention

As described in detail above, according to the first to seventh aspects of the present invention, it is possible to provide a paint mist removal device that allows easy replacement of filters.

### BRIEF DESCRIPTION OF THE DRAWINGS

FIG. 1 is a schematic sectional view showing a coating equipment according to the present embodiment.

FIG. 2 is a front view showing a paint mist removal device.

FIG. 3 is a side sectional view showing the paint mist removal device.

FIG. 4 is a perspective view showing a corrugated cardboard filter.

FIG. 5 is a sectional view showing a lower housing section and the corrugated cardboard filter.

FIG. 6 is a plan view of an essential part showing an end portion of a holding member.

FIG. 7 is a perspective view of an essential part showing a state in which the holding member is attached.

FIG. 8 is a sectional view showing a state in which a guide member is provided between the corrugated cardboard filter and a secondary filter.

FIG. 9 is a sectional view showing an upper housing section and the secondary filter.

FIG. 10 is a schematic sectional view showing a state in which the corrugated cardboard filter and the secondary filter are inserted into and removed from the filter housing body.

FIG. 11 is a perspective view showing the paint mist removal device with a door opened.

FIG. 12(a) is a sectional view showing a state before the corrugated cardboard filter is accommodated, and FIG. 12(b) is a sectional view showing a state after the corrugated cardboard filter is accommodated.

FIG. 13 is an explanatory view showing another embodiment of the holding member.

FIG. 14 is an explanatory view showing another embodiment of the holding member.

FIG. 15 is a sectional view showing a lower housing section and the corrugated cardboard filter in another embodiment.

FIG. 16 is a schematic sectional view showing a coating equipment according to another embodiment.

FIG. 17 is a schematic sectional view showing a coating equipment in the related art.

### BEST MODE FOR CARRYING OUT THE INVENTION

Hereinafter, an embodiment embodying the present invention will be described in detail with reference to the drawings.

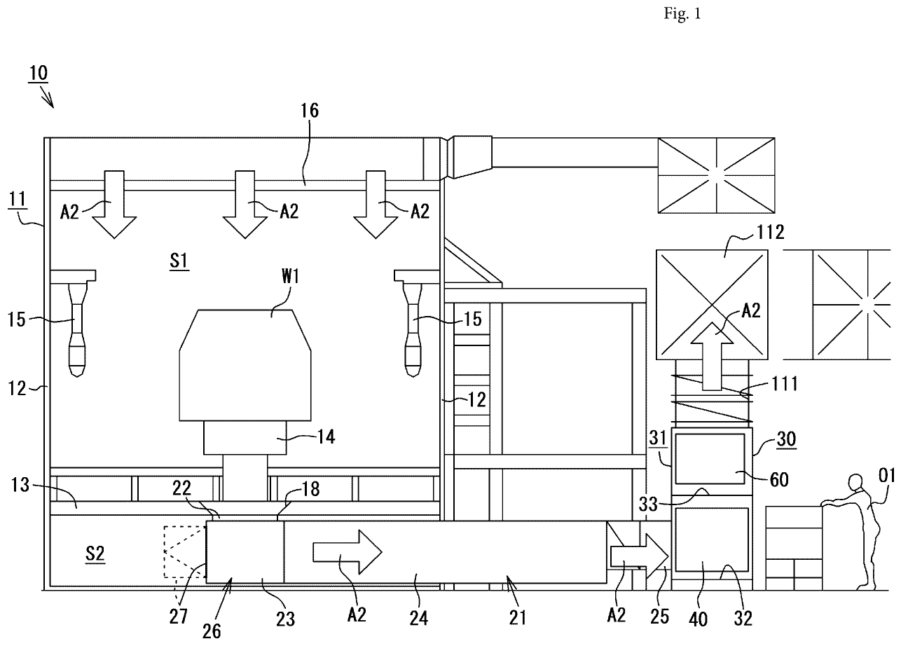

As shown in FIG. 1, a coating equipment 10 according to the present embodiment includes a paint booth 11 and a paint mist removal device 30. The paint booth 11 has a pair of side walls 12 and a floor portion 13. A booth space S1 is partitioned above the floor portion 13 of the paint booth 11, and a booth underfloor space S2 is partitioned below the floor portion 13. A coating line 14 extending in a longitudinal direction (a direction orthogonal to the plane of FIG. 1) and a plurality of coating robots 15 arranged on both sides of the coating line 14 are accommodated in the booth space S1. In the paint booth 11, an object to be coated W1 (a vehicle body in this embodiment) is coated by spraying atomized paint (paint mist) from coating guns of the coating robots 15 onto the object W1 while the object W1 is conveyed along the longitudinal direction of the coating line 14.

In addition, a ceiling wall 16 is provided at an upper portion of the booth space S1. The ceiling wall 16 has a mesh structure, and booth air A2 is supplied to the upper side of the ceiling wall 16. As a result, the booth air A2 flows downward through the ceiling wall 16 into the paint booth 11, whereby paint mist that has not adhered to the object to be coated W1 is guided downward. On the other hand, an exhaust port 18 is provided at a central portion of the floor portion 13.

As shown in FIG. 1, an air transfer passage 21 connecting the booth space S1 and the paint mist removal device 30 is formed in the booth underfloor space S2. The air transfer passage 21 includes a descending duct 22, a direction changing section 23, and a transverse duct 24. The descending duct 22 has a rectangular cross section and extends downward from an exhaust port 18 provided at a central portion of the floor portion 13. The direction changing section 23 has a box-shaped structure and is connected to a distal end of the descending duct 22. The direction changing section 23 changes the traveling direction of the booth air A2 that has passed through the descending duct 22 from a downward direction to a lateral direction (to the right in FIG. 1). The transverse duct 24 also has a rectangular cross section, and its proximal end is connected to the direction changing section 23, while its distal end is connected to the paint mist removal device 30 through a connecting duct 25. The transverse duct 24 penetrates the side wall 12, protrudes outward from the paint booth 11 (outside the booth underfloor space S2), and extends laterally toward the paint mist removal device 30 (to the right in FIG. 1). The connecting duct 25 also has a rectangular cross section and extends laterally toward the paint mist removal device 30 (to the right in FIG. 1).

As shown in FIG. 1, the direction changing section 23 located at a position on the air transfer passage 21 serves as a dust collecting section 26. The dust collecting section 26 removes or collects part of the paint mist contained in the booth air A2 by causing the booth air A2 that has passed through the descending duct 22 to collide with an inner surface (particularly a bottom surface) of the dust collecting section 26, thereby allowing the paint mist to adhere to the bottom surface. A door 27 for closing the dust collecting section 26 is provided on a side portion of the dust collecting section 26, specifically, on a side portion opposite to a connection portion with the transverse duct 24 (on the left side in FIG. 1).

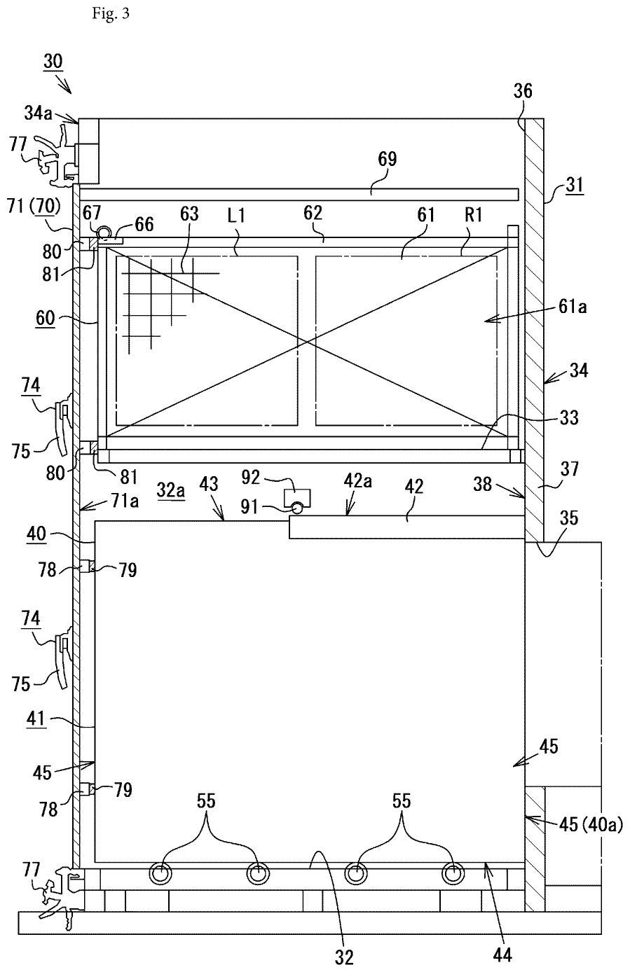

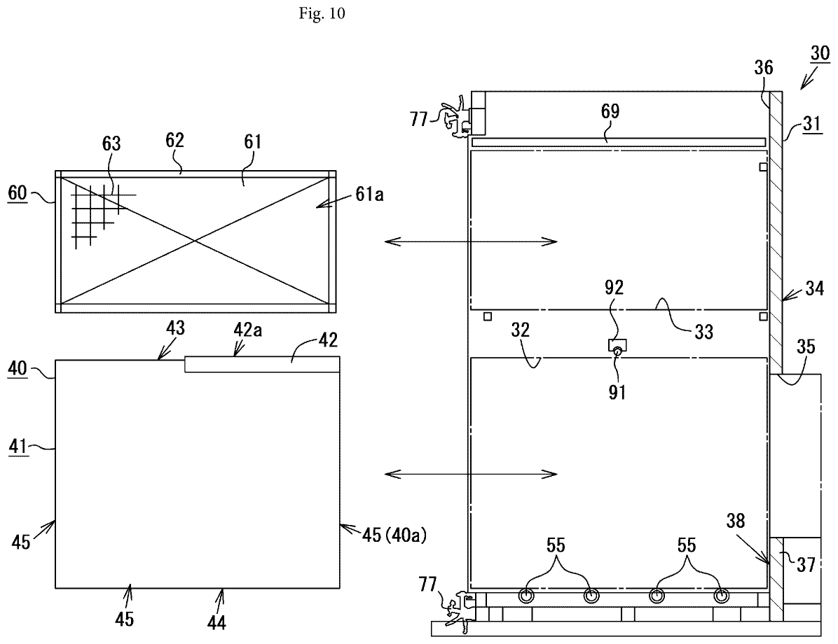

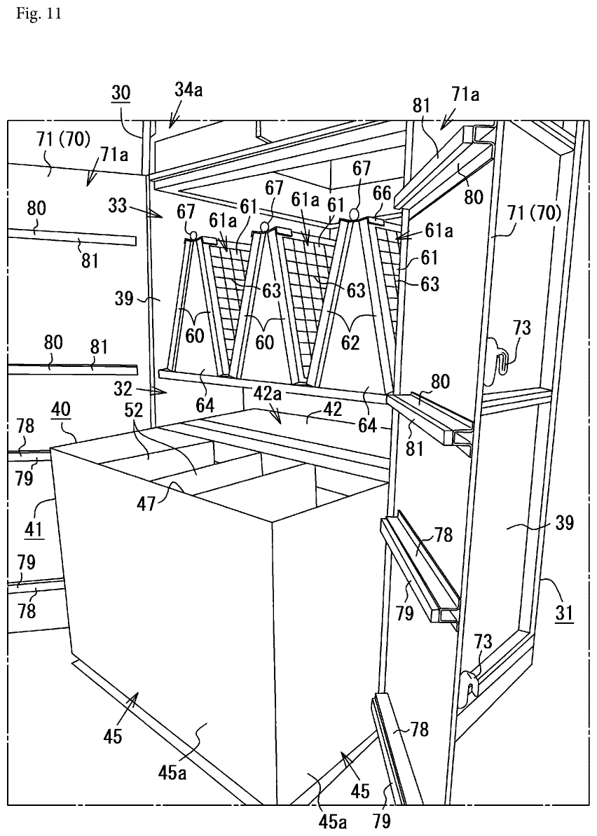

As shown in FIGS. 1 and 3, the paint mist removal device 30 includes a filter housing body 31 that can accommodate one corrugated cardboard filter 40 (primary filter) and six secondary filters 60 arranged in stages. The paint mist removal device 30 serves to remove paint mist contained in the booth air A2 by passing the booth air A2 discharged from the booth space S1 through the corrugated cardboard filter 40 and the secondary filters 60. Specifically, the filter housing body 31 includes a lower housing section 32 and an upper housing section 33 disposed adjacent to an upper side of the lower housing section 32. The lower housing section 32 is configured to allow insertion and removal of the corrugated cardboard filter 40 (see FIGS. 10 and 11), and the upper housing section 33 is configured to allow insertion and removal of each secondary filter 60 (see FIG. 10). Therefore, the corrugated cardboard filter 40 and the secondary filters 60 are arranged vertically adjacent to each other within the filter housing body 31.

As shown in FIGS. 3, 5, 9, and 10, a side surface 34 of the filter housing body 31—specifically, a portion of the side surface 34 located on the opposite side of an opening of the lower housing section 32—is provided with an inlet 35. The inlet 35 is connected to a terminal end of the connecting duct 25, and serves to introduce the booth air A2 into the corrugated cardboard filter 40 within the lower housing section 32. Furthermore, at a position higher than the inlet 35 in the filter housing body 31×specifically, at an upper end of the filter housing body 31—an outlet 36 is provided. The outlet 36 serves to discharge the booth air A2 that has passed through the secondary filters 60 in the upper housing section 33. In addition, an inner surface 38 of a side wall 37 of the filter housing body 31, on which the inlet 35 is provided, is in surface contact with an air intake surface 40a (side surface 45) of the corrugated cardboard filter 40 accommodated in the lower housing section 32.

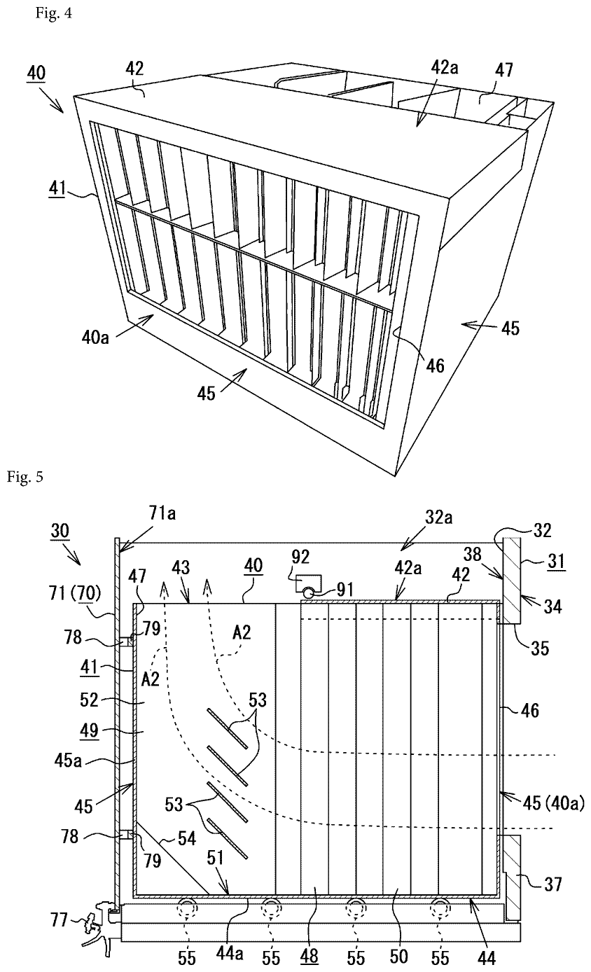

The corrugated cardboard filter 40 is formed mainly of a combustible material, specifically corrugated cardboard. As shown in FIGS. 3 to 5, 10, and 11, the corrugated cardboard filter 40 includes a filter body 41 and an upper lid portion 42. The filter body 41 has an upper surface 43, a lower surface 44, and four side surfaces 45, and is formed in a rectangular parallelepiped (box-like) shape. Furthermore, the filter body 41 has a rectangular inlet 46 (see FIG. 4) that opens at a side surface 45 on an upstream side (the right side in FIG. 5), which serves as an air intake surface 40a, and a rectangular outlet 47 (see FIGS. 4 and 11) that opens at the upper surface 43. The upper lid portion 42 covers the upper surface 43 of the filter body 41, except for the outlet 47. In the filter body 41 of the present embodiment, the booth air A2 containing paint mist is taken in through the inlet 46, passes through the interior, and is discharged from the outlet 47. The booth air A2 discharged from the outlet 47 is guided into the upper housing section 33.

As shown in FIG. 5, the filter body 41 is provided with an eliminator 48 and a rectifying plate 49. The eliminator 48 is accommodated near the inlet 46 within the filter body 41. The eliminator 48 includes a plurality of plate-shaped eliminator elements 50 arranged side by side, and functions to separate paint mist from the booth air A2. Each eliminator element 50 extends in a vertical direction, with its lower end in contact with a bottom surface 51 of the filter body 41. The bottom surface 51 is parallel to the upper surface 43 and the lower surface 44 of the filter body 41. Each eliminator element 50 has a zigzag shape in a plan view. Accordingly, a meandering passage is formed between adjacent eliminator elements 50.

The rectifying plate 49 is accommodated near the outlet 47 within the filter body 41. The rectifying plate 49 is composed of a plurality of plate-shaped rectifying plate elements 52 arranged side by side. Each rectifying plate element 52 extends in a vertical direction, with its lower end in contact with the bottom surface 51 of the filter body 41. Each rectifying plate element 52 also extends in a horizontal direction (in the left-right direction in FIG. 5), and an upstream end of each rectifying plate element 52 is connected to a downstream end of each eliminator element 50.

As shown in FIG. 5, the rectifying plate 49 is provided with four guide plates 53 that interconnect the respective rectifying plate elements 52. Each guide plate 53 is arranged at equal intervals along a vertical direction. Each guide plate 53 is orthogonal to the respective rectifying plate elements 52 and extends in a horizontal direction (in a depth direction in FIG. 5). Each guide plate 53 is inclined with respect to the upper surface 43, the lower surface 44, and the bottom surface 51 of the filter body 41, and functions to guide the booth air A2—which is introduced from the inlet 46 and has passed through the eliminator 48—toward the outlet 47.

Furthermore, the rectifying plate 49 is provided with a guide plate 54 at its lower end portion (at the lower left portion inside the filter body 41 in FIG. 5). The guide plate 54 has an upstream end (a lower end) that is in contact with a bottom portion 44a (the bottom surface 51) of the filter body 41, and a downstream end (an upper end) that is in contact with a side portion 45a (the left side portion in FIG. 5) of the filter body 41. The guide plate 54 is inclined with respect to the upper surface 43, the lower surface 44, and the bottom surface 51 of the filter body 41, and functions to guide the booth air A2, which is introduced from the inlet 46 and has passed through the eliminator 48, toward the outlet 47.

It should be noted that the filter body 41, the upper lid portion 42, the eliminator 48, and the rectifying plate 49 described above have a foldable structure. In this embodiment, the constituent components of the corrugated cardboard filter 40—namely the filter body 41, the upper lid portion 42, the eliminator 48, and the rectifying plate 49—are transported in a flat, folded state. The corrugated cardboard filter 40 is completed by assembling these components in an unfolded state. When the corrugated cardboard filter 40 becomes contaminated with paint mist, it is removed from the lower housing section 32 and incinerated as is, without being folded. That is, the paint mist is discarded together with the corrugated cardboard filter 40.

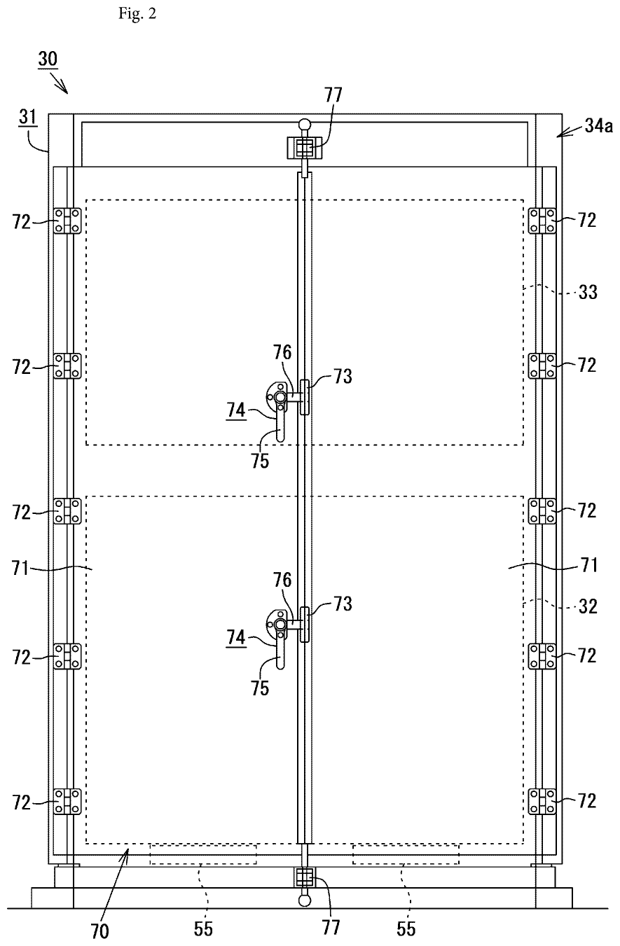

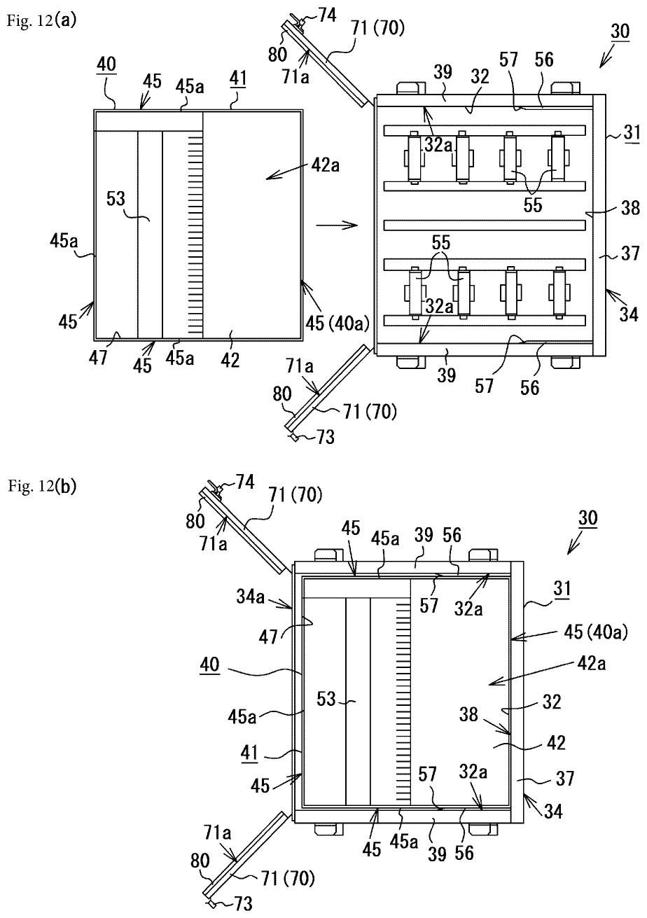

As shown in FIGS. 2, 3, 5, and 10, a plurality of rollers 55 are rotatably arranged at predetermined intervals on a bottom portion of the lower housing section 32. Rotational shafts of the respective rollers 55 are oriented orthogonally to the insertion/removal direction of the corrugated cardboard filter 40 (in the left-right direction in FIG. 10). The dimension of each roller 55 in the shaft direction is set to be smaller than the depth dimension of the corrugated cardboard filter 40. All rollers 55 are disposed at the same height and are arranged in a straight line along the insertion/removal direction of the corrugated cardboard filter 40, thereby forming two rows of roller groups 55 (see FIGS. 2 and 12(a)). The two roller groups 55 are spaced apart from each other in the depth direction of the corrugated cardboard filter 40. Accordingly, the outer peripheral surfaces of the respective rollers 55 come into contact with the lower surface 44 side of the corrugated cardboard filter 40, thereby supporting the corrugated cardboard filter 40 from below. Each roller 55 rolls during transportation of the corrugated cardboard filter 40, thereby promoting smooth movement of the corrugated cardboard filter 40.

As shown in FIG. 12, a pair of guide members 56, each having a rectangular cross section, are projectingly provided on a pair of inner surfaces 32a that constitute the lower housing section 32. The inner surfaces 32a are the inner surfaces of a pair of side walls 39 that are orthogonal to the side wall 37 on which the inlet 35 of the filter housing body 31 is provided. Both guide members 56 are rod-shaped members extending along the insertion/removal direction of the corrugated cardboard filter 40. Specifically, the distal ends (the left ends in FIG. 12) of both guide members 56 are positioned near the central portion of the side walls 39, and the proximal ends (the right ends in FIG. 12) of both guide members 56 are connected to the side wall 37. Accordingly, the length of each guide member 56 is approximately half of the width of the side wall 39 (the length in the left-right direction in FIG. 12). The opposing inner surfaces 32a of both side walls 39 are spaced slightly wider than the depth dimension of the corrugated cardboard filter 40. Furthermore, the distal end surfaces (the upper or lower end surfaces in FIG. 12) of both guide members 56 are spaced apart by a distance corresponding to the depth dimension of the corrugated cardboard filter 40. End portions of both guide members 56 on the side of the opening/closing door 70 are each provided with a tapered surface 57 inclined relative to the inner surfaces 32a. By these tapered surfaces 57, the dimension of the lower housing section 32 in the width direction (the vertical direction in FIG. 12) gradually decreases toward the base end side (the right side in FIG. 12) of the guide members 56.

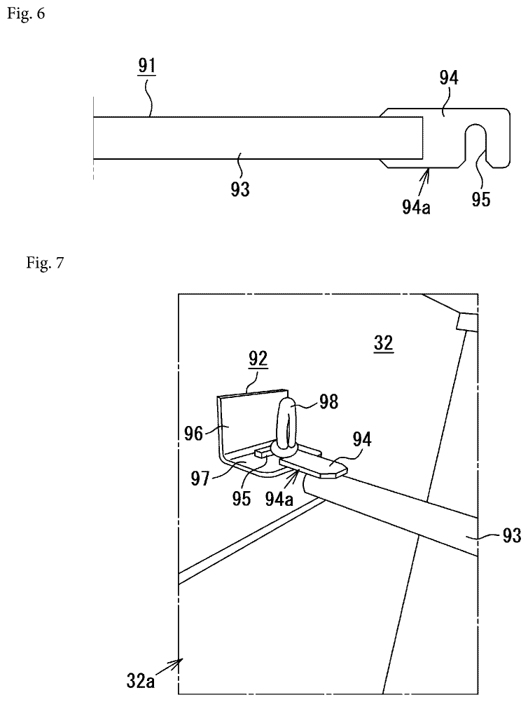

As shown in FIGS. 3, 5, 6, 7, and 10, an holding member 91 that can come into contact with the upper surface 43 of the filter body 41 is provided on an upper portion of the inner surface 32a of the lower housing section 32. Specifically, the holding member 91 includes a rod-shaped member 93 having a circular cross-section that extends in the depth direction of the corrugated cardboard filter 40, and is provided at a position where it can come into contact with the upper surface 42a of the upper lid portion 42. In detail, the holding member 91 is disposed above a distal end portion (the left end portion in FIG. 5) of the upper lid portion 42, in the vicinity of the outlet 47. The length of the holding member 91 is substantially equal to the distance between the pair of side walls 39 that constitute the filter housing body 31.

In addition, the holding member 91 is detachably provided with respect to the lower housing section 32. Specifically, plate-shaped members 94 having a substantially rectangular shape are provided on outer peripheral surfaces of both end portions of the rod-shaped member 93. Each plate-shaped member 94 is formed with an engagement recess 95 that opens at one of its side end surfaces 94a. Meanwhile, a pair of support members 92 for supporting the plate-shaped members 94 of the holding member 91 are provided on the pair of inner surfaces 32a that constitute the lower housing section 32. As shown in FIG. 7, each support member 92 is formed into a substantially L-shaped cross section by bending a rectangular metal plate, and includes an attachment plate 96 attached to the inner surface 32a, and a support plate 97 projecting from a lower end portion of the attachment plate 96. To mount the plate-shaped members 94 on the support members 92, first, the plate-shaped member 94 provided at one end of the rod-shaped member 93 is placed on the support plate 97 of the support member 92 located on one inner surface 32a side. Similarly, the plate-shaped member 94 provided at the other end of the rod-shaped member 93 is placed on the support plate 97 of the support member 92 located on the other inner surface 32a side. Then, at both end portions of the holding member 91, a bolt 98 (such as an eye bolt) is inserted through both the engagement recess 95 of the plate-shaped member 94 and a bolt insertion hole (not shown) of the support plate 97, and a nut (not shown) is screwed onto the leading end of the inserted bolt 98. As a result, the plate-shaped members 94 and support members 92 are fastened to each other, whereby the holding member 91 is attached to the lower housing section 32.

As shown in FIGS. 3 and 9 to 11, the secondary filter 60 includes two sheet-like filter elements 61, a filter frame 62, and a pair of mesh members 63. Each sheet-like filter element 61 is formed into a rectangular plate shape mainly from a combustible material (specifically, flame-retardant processed paper). Each sheet-like filter element 61 serves to remove paint mist contained in the booth air A2 by allowing the booth air A2 discharged from the corrugated cardboard filter 40 to pass therethrough. The filter frame 62 has a rectangular frame shape and holds outer peripheral portions of the two sheet-like filter elements 61. Each mesh member 63 has its outer peripheral portion held by the filter frame 62 and supports an air inflow surface (not shown) and an air outflow surface 61a of each sheet-like filter element 61, respectively. Accordingly, detachment of the sheet-like filter elements 61 from the filter frame 62 is prevented.

As shown in FIGS. 9 and 11, three secondary filter mounting portions 64 are accommodated within the upper housing section 33. Each secondary filter mounting portion 64 is arranged side by side along a lateral direction (the left-right direction in FIG. 9). Each secondary filter mounting portion 64 has a trapezoidal shape having inclined surfaces 65 on both sides (the left and right sides in FIG. 9). By closely attaching the secondary filters 60 to the respective inclined surfaces 65, a pair of secondary filters 60 are mounted on each secondary filter mounting portion 64 such that the filters approach each other toward the top, that is, are arranged in a trapezoidal configuration. At this time, the air inflow surface of each sheet-like filter element 61 faces toward the corresponding inclined surface 65.

Furthermore, a holding member 66 is provided at an upper end portion of each secondary filter mounting portion 64. Each holding member 66 is formed into a substantially U-shaped cross section by bending a rectangular metal plate. The holding member 66 serves to hold upper portions of the filter frames 62 of the pair of secondary filters 60 mounted on each secondary filter mounting portion 64. Accordingly, each secondary filter 60 closely contacts the corresponding secondary filter mounting portion 64. An eye bolt 67 is inserted through a central portion of the holding member 66 and an upper end portion of the secondary filter mounting portion 64, and a nut 68 is screwed onto a leading end of the inserted eye bolt 67, whereby the holding member 66 and the secondary filter mounting portion 64 are fastened to each other. As a result, each secondary filter 60 mounted on the secondary filter mounting portion 64 is fixed in position.

As shown in FIGS. 3, 9, and 10, an airflow regulating plate 69 is provided at an upper portion of the upper housing section 33 to adjust the airflow rate of the booth air A2 that has passed through each secondary filter 60. The airflow regulating plate 69 may be configured to adjust the airflow rate of the booth air A2 by sliding a panel that constitutes a part of the airflow regulating plate 69 (i.e., moving the panel in the surface direction of the airflow regulating plate 69), or alternatively, by removing the panel.

As shown in FIGS. 2, 11, and 12, on a side surface 34a of the filter housing body 31, which is located opposite to the side surface 34 where the inlet 35 is provided (that is, the side surface 34a on which the opening of the lower housing section 32 and the opening of the upper housing section 33 are positioned), an opening/closing door 70 composed of a pair of pivoting doors 71 is provided. Both pivoting doors 71 are rotatably connected via a plurality of hinges 72 provided on both side edge portions of the side surface 34a, and each door closes half of the opening of the lower housing section 32 and half of the opening of the upper housing section 33, respectively. Accordingly, the opening/closing door 70 in this embodiment serves as a common door for the insertion and removal of the corrugated cardboard filter 40 in the lower housing section 32, and the secondary filter 60 in the upper housing section 33. Therefore, when the opening/closing door 70 is opened, both the replacement of the corrugated cardboard filter 40 and the replacement of the secondary filter 60 can be carried out.

As shown in FIG. 2, on the front surface of one of the pair of pivoting doors 71 constituting the opening/closing door 70 (the right-hand door in FIG. 2), a pair of engaging portions 73 are provided. On the front surface of the other pivoting door 71 (the left-hand door in FIG. 2) without the engaging portions 73, a pair of lock levers 74 are provided. Each lock lever 74 is rotatably supported on the pivoting door 71 and includes an operation bar 75 and an actuating bar 76. When the operation bar 75 is rotated, the actuating bar 76 enters into the engaging portion 73, thereby locking the pair of pivoting doors 71 in a closed state.

As shown in FIG. 2, toggle clamps 77 are respectively attached to the center of the lower edge of the opening of the lower housing section 32 and to the center of the upper edge of the opening of the upper housing section 33. Each toggle clamp 77 includes an operation bar and an actuating bar that rotate about a pivot shaft extending in the lateral direction, and a toggle mechanism connecting the two bars. When the operation bar is rotated, a pressing member provided at the distal end of the actuating bar presses against a pressed member projecting from the front surface of the pivoting door 71, thereby restricting rotation of the pivoting door 71 in its closed state.

As shown in FIGS. 3, 5, and 11, on the inner surfaces 71a of the pair of pivoting doors 71 (the opening/closing door 70), two corrugated filter contact portions 78 (primary filter contact portions) are provided at positions facing the corrugated filter 40 housed in the lower housing section 32. The upper corrugated filter contact portion 78 is in contact with an upper part of the filter body 41, and the lower corrugated filter contact portion 78 is in contact with a lower part of the filter body 41. Each corrugated filter contact portion 78 extends in the width direction of the pivoting door 71, and its surface is covered with a belt-like elastic member 79 made of an elastic material such as chloroprene rubber.

As shown in FIGS. 3 and 11, on the inner surfaces 71a of the pair of pivoting doors 71, two secondary filter contact portions 80 are provided at positions facing the secondary filters 60 housed in the upper housing section 33. The upper secondary filter contact portion 80 is in contact with an upper end portion of the filter frame 62, and the lower secondary filter contact portion 80 is in contact with a lower end portion of the filter frame 62. Each secondary filter contact portion 80 extends in the width direction of the pivoting door 71, and its surface is covered with a belt-like elastic member 81 made of an elastic material such as chloroprene rubber.

As shown in FIG. 1, a starting end of an ascending duct 111 is connected to the outlet 36 (see FIGS. 3, 9, and 10) of the filter housing body 31. The ascending duct 111 has a rectangular cross section and extends upward from the outlet 36. An exhaust duct 112 is connected to a terminal end of the ascending duct 111, and discharges the booth air A2 that has been exhausted from the outlet 36 and has passed through the ascending duct 111.

The inside of the air transfer passage 21, the filter housing body 31, the ascending duct 111, and the exhaust duct 112 are kept in a negative pressure state by a blower (not shown). Accordingly, the booth air A2 in the coating booth 11 flows into the paint mist removal device 30 after passing through the air transfer passage 21. The paint mist contained in the booth air A2 is removed while passing through the dust collecting portion 26 and the paint mist removal device 30.

Next, a method for removing the paint mist contained in the booth air A2 will be described.

First, when coating of a workpiece W1 is performed by spraying paint from a coating gun of a coating robot 15, oversprayed paint mist is guided to the booth underfloor space S2 together with the booth air A2 in the booth space S1, after passing through the exhaust port 18 provided in the floor portion 13 of the coating booth 11.

Subsequently, the booth air A2 containing the paint mist passes through the downward duct 22 of the air transfer passage 21 formed in the booth underfloor space S2 and is guided to the direction-changing section 23 (dust collecting section 26). When the booth air A2 collides with the inner surface (particularly the bottom surface) of the dust collecting section 26, a portion of the paint mist contained in the booth air A2 adheres to the inner surface. Thus, the dust collecting section 26 performs dust collection of the paint mist. Further, when the booth air A2 collides with the inner surface of the dust collecting section 26 (direction-changing section 23), the traveling direction of the booth air A2 is changed from the downward direction to the lateral direction (to the right in FIG. 1). The booth air A2, whose traveling direction has been changed, then flows into the lateral duct 24 of the air transfer passage 21. After passing through the lateral duct 24, the booth air A2 passes through the connecting duct 25, then sequentially through the inlet 35 of the filter housing body 31 (paint mist removal device 30) and the inlet 46 of the corrugated cardboard filter 40 (filter body 41) in the lower housing section 32, and is taken into the interior of the filter body 41 (see FIG. 5).

Then, the booth air A2 is guided to the eliminator 48 and flows between adjacent eliminator elements 50. Each eliminator element 50 has a zigzag shape when viewed in plan, so that a meandering passage is formed between adjacent eliminator elements 50. As a result, the booth air A2 flows through the meandering passage while colliding with the surfaces of the eliminator elements 50, and most of the paint mist contained in the booth air A2 is removed as it adheres to the surfaces of the eliminator elements 50.

Next, the booth air A2 that has passed through the eliminator 48 is guided to the rectifying plate 49 located downstream of the eliminator 48 (to the left in FIG. 5) and flows between adjacent rectifying plate elements 52. At this time, the booth air A2 comes into contact with the surfaces of the rectifying plate elements 52, whereby it is guided along the surfaces of the rectifying plate elements 52. As a result, the flow of the booth air A2 becomes uniform. In addition, a part of the paint mist contained in the booth air A2 is removed as it adheres to the surfaces of the rectifying plate elements 52. Furthermore, the booth air A2 changes its traveling direction from the lateral direction (to the left in FIG. 5) to the upward direction as it comes into contact with the surfaces of the guide plates 53. At this time, a part of the paint mist contained in the booth air A2 is also removed as it adheres to the surfaces of the guide plates 53.

Thereafter, the booth air A2 is discharged from the outlet 47 to the outside of the filter body 41 and is guided into the upper housing section 33. The booth air A2 is further guided into an internal space S3 (see FIG. 9) of the secondary filter mounting portion 64 installed in the upper housing section 33, and passes through the sheet-like filter elements 61 in the secondary filter 60 from the air inflow side surface to the air outflow side surface 61a (see FIG. 11). At this time, the paint mist contained in the booth air A2 is removed as it adheres to the air inflow side surface and other surfaces of the sheet-like filter elements 61. At this stage, almost all of the paint mist contained in the booth air A2 is removed.

Then, the booth air A2 from which the paint mist has been removed passes through the air volume adjustment plate 69 in the upper housing section 33, and is discharged from the outlet 36 to the outside of the filter housing body 31. The booth air A2 then passes through the upward duct 111 and is discharged to the outside of the coating equipment 10 through the exhaust duct 112.

As shown in FIG. 10, in the paint mist removal device 30, replacement work for the corrugated cardboard filter 40 and the secondary filter 60 is performed as necessary. The replacement operation is carried out while the coating equipment 10 is in a stopped state.

For example, when the amount of paint mist accumulated in the corrugated cardboard filter 40 reaches a specified value (for example, 45 kg), the corrugated cardboard filter 40 is replaced with a new one. The weight of the paint mist adhering to the corrugated cardboard filter 40 is measured by a weighing instrument (not shown) provided in the paint mist removal device 30 after the corrugated cardboard filter 40 has been installed. Based on the measured weight of the paint mist, the replacement cycle of the corrugated cardboard filter 40 is determined. Thereafter, the corrugated cardboard filter 40 is periodically replaced at the determined replacement cycle. In addition, a pressure sensor (not shown) installed in the paint mist removal device 30 measures the pressure difference before and after use of the corrugated cardboard filter 40, and the amount of paint mist adhering to the corrugated cardboard filter 40 is estimated based on the measured pressure difference.

When replacing the corrugated cardboard filter 40, the coating equipment 10 is first kept in a stopped state, and an empty cart (not shown) is placed in front of the paint mist removal device 30 (to the left in FIG. 10). At the same time, another cart carrying a new corrugated cardboard filter 40 (not shown) is placed beside the empty cart. Then, an operator O1 opens the opening/closing door 70 of the paint mist removal device 30, grasps the corrugated cardboard filter 40, pulls it out from the lower housing section 32, and places it on the empty cart.

That is, in the paint mist removal device 30 of the present embodiment, the corrugated cardboard filter 40 in which paint mist has accumulated can be taken out directly from the lower housing section 32 and transported, thereby preventing the scattering of paint mist. When a new corrugated cardboard filter 40 is carried into the lower housing section 32 from the cart and the opening/closing door 70 is closed, replacement of the corrugated cardboard filter 40 is completed. The used corrugated cardboard filter 40 is then, for example, transported to an incineration facility, unloaded from the cart, and incinerated.

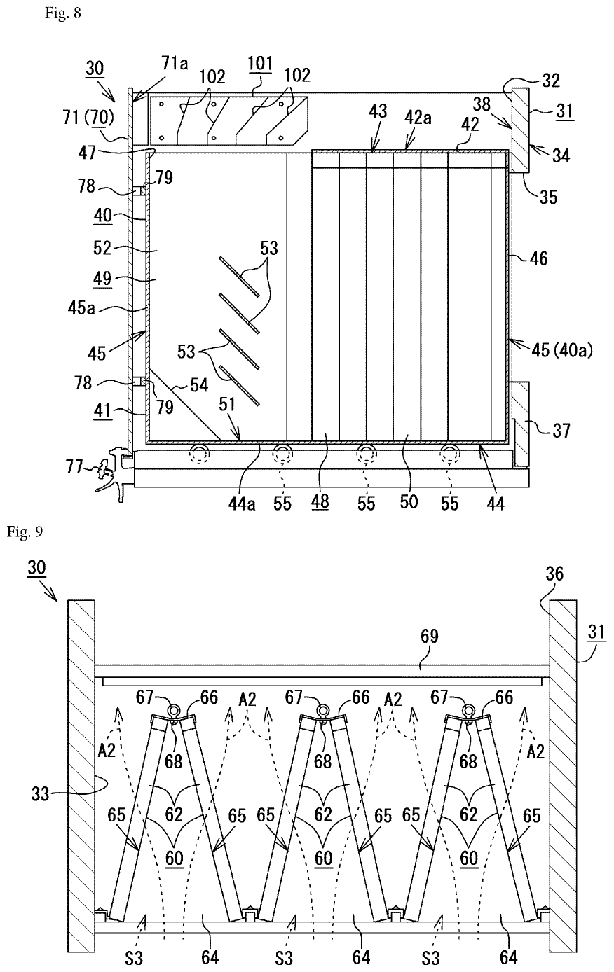

Accordingly, the following advantages can be achieved in the present embodiment.
(1) In the paint mist removal device 30 of the present embodiment, the upper housing section 33 is arranged adjacent to and above the lower housing section 32. This configuration allows either the corrugated cardboard filter 40 or the secondary filter 60 to be replaced without interference from the other filter or from other structures (for example, the coating booth 11). In addition, by arranging the upper housing section 33 adjacent to and above the lower housing section 32, the installation area of the filter housing body 31 (the paint mist removal device 30) can be reduced, thereby increasing the degree of freedom in installing the paint mist removal device 30.
(2) In the paint mist removal device 30 of the present embodiment, the corrugated cardboard filter 40 is accommodated in the lower part (the lower housing section 32) of the filter housing body 31. Accordingly, even when the corrugated cardboard filter 40 becomes heavy as paint mist accumulates (for example, when it reaches a weight of 45 kg or more), it is sufficient to pull out the corrugated cardboard filter 40 from the lower housing section 32, and there is almost no need to move the corrugated cardboard filter 40 in the vertical direction, thereby facilitating the removal work of the corrugated cardboard filter 40. If the corrugated cardboard filter 40 were accommodated in the upper part (the upper housing section 33), the heavy corrugated cardboard filter 40 would have to be moved in the vertical direction, making the removal work difficult.
(3) In the paint mist removal device 30 of the present embodiment, a holding member 91 is brought into contact with the upper surface 42a of the upper lid portion 42 of the corrugated cardboard filter 40. This prevents the upper lid portion 42 from being lifted even if an upward force acts on the upper lid portion 42 due to the airflow pressure of the booth air A2. Accordingly, it becomes possible to prevent paint mist from leaking through a gap formed between the filter body 41 and the upper lid portion 42 as a result of such lifting, thereby preventing a reduction in the dust collection efficiency of the corrugated cardboard filter 40. Moreover, the lifting of the upper lid portion 42 and its deformation or breakage are prevented. Additionally, since the deformation of the corrugated cardboard filter 40 caused by the upward force can also be prevented, the dust collection performance of the corrugated cardboard filter 40 is maintained.
(4) In the present embodiment, the holding member 91 is disposed above the front end portion (the left end portion in FIG. 5) of the upper lid portion 42, that is, in the vicinity of the outlet 47 through which the booth air A2 passes. Accordingly, even if an upward force acts on the upper lid portion 42 due to the airflow pressure of the booth air A2, the holding member 91 comes into contact with the front end portion of the upper lid portion 42, which is susceptible to the influence of such a force because it is located close to the outlet 47. This makes it possible to effectively prevent the upper lid portion 42 from lifting.
(5) For example, in order to uniformly guide the booth air A2 discharged from the corrugated cardboard filter 40 to the entire secondary filter 60, a modification may be considered in which a guide member 101 (see FIG. 8) is provided between the corrugated cardboard filter 40 and the secondary filter 60. Specifically, the guide member 101 includes four guide plates 102. The lower ends of the respective guide plates 102 are arranged at equal intervals along the direction in which the corrugated cardboard filter 40 is inserted and removed (the left-right direction in FIG. 8). On the other hand, the upper portions of the respective guide plates 102 extend obliquely upward (toward the upper right in FIG. 8). Each guide plate 102 functions to guide the booth air A2 discharged from the corrugated cardboard filter 40 toward the secondary filter 60.

However, when the guide member 101 is provided, the paint (paint mist) adhering to the guide plates 102 may drip down and become stuck to the corrugated cardboard filter 40. In this case, during replacement of the corrugated cardboard filter 40, even if the operator O1 attempts to remove the corrugated cardboard filter 40 from the lower housing section 32, the upper lid portion 42 may interfere with the guide member 101, making it difficult to move the corrugated cardboard filter 40. As a result, there is a problem in that the workability of the replacement operation deteriorates.

Accordingly, in the present embodiment, the guide member 101 that has been conventionally provided is omitted. As a result, since the risk of the corrugated cardboard filter 40 becoming stuck is reduced, the operator O1 can smoothly remove the corrugated cardboard filter 40 from the lower housing section 32. Therefore, the workability of the replacement operation for the corrugated cardboard filter 40 is improved. Furthermore, when the guide member 101 is omitted, the booth air A2 discharged from the corrugated cardboard filter 40 first accumulates in the left-side region L1 of the secondary filter 60 (see FIG. 3). As a result, the booth air A2 gradually becomes unable to pass through the left-side region L1, and accordingly is guided toward the right-side region R1 of the secondary filter 60 (see FIG. 3). Therefore, even in the absence of the guide member 101, no uneven adhesion of the paint mist to the secondary filter 60 occurs.
(6) In the present embodiment, the inner surfaces 71a of the pair of swing doors 71 constituting the opening and closing door 70 are provided with the corrugated cardboard filter contact portions 78 and the secondary filter contact portions 80. The corrugated cardboard filter contact portions 78 come into contact with the corrugated cardboard filter 40, while the secondary filter contact portions 80 come into contact with the secondary filter 60. This prevents the corrugated cardboard filter 40 and the secondary filter 60 from being displaced by vibration or the like. In addition, since the corrugated cardboard filter contact portions 78 fill the gap between the corrugated cardboard filter 40 and the opening and closing door 70, leakage of paint mist from the lower housing section 32 in which the corrugated cardboard filter 40 is accommodated can be prevented. Similarly, since the secondary filter contact portions 80 fill the gap between the secondary filter 60 and the opening and closing door 70, leakage of paint mist from the upper housing section 33 in which the secondary filter 60 is accommodated can be prevented.
(7) In the present embodiment, the filter body 41, the upper lid portion 42, the eliminator 48, and the rectifying plate 49, which are components of the corrugated cardboard filter 40, have a foldable structure. As a result, since the components of the corrugated cardboard filter 40 can be folded and transported in a reduced state, the load associated with transportation can be reduced. In addition, since the components can be stored in a folded and compact state, it becomes easier to secure a storage space.

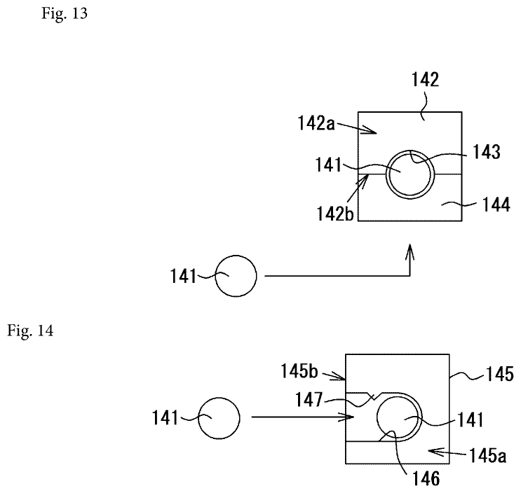

It should be noted that the above embodiment may be modified as follows.
In the above embodiment, the holding member 91 is provided at a position above the distal end portion of the upper lid portion 42 (the left end in FIG. 5) and in the vicinity of the outlet 47. However, the holding member 91 may be provided at a position above the central portion of the upper lid portion 42, or at a position above the proximal end portion of the upper lid portion 42 (the right end in FIG. 5). In addition, although the holding member 91 was provided only at one location in an upper part of the inner surface 32a of the lower housing section 32, it may be provided at a plurality of locations.
In the above embodiment, the holding member 91 includes a rod-shaped member 93 having a circular cross section. However, the holding member 91 may include a rod-shaped member having another cross-sectional shape, such as a rectangular cross section or a triangular cross section. The holding member 91 may also be a plate-shaped member or the like having a predetermined width. Furthermore, in the above embodiment, the rod-shaped member 93 of the holding member 91 is provided so as to connect the support members 92 on both side walls 39 of the filter housing body 31. However, a rod-shaped member shorter than the rod-shaped member 93 in the above embodiment may be provided on each of the support members 92. In this case, the rod-shaped member may be detachably provided on the support members 92, or may be foldably provided.
In the above embodiment, the structures of the holding member 91 and the support member 92 may be modified. For example, as shown in FIG. 13, the holding member 91 may be replaced with a holding member 141 that does not have plate-shaped members 94 at both ends of the rod-shaped member 93. The support member 92 may also be replaced with a support member 142 provided with an engagement recess 143 that opens at a front surface 142a and a lower surface 142b. In this case, when one end of the holding member 141 is inserted from below the support member 142 into the engagement recess 143 and a fixing member 144 is attached to the lower surface 142b side of the support member 142, one end of the holding member 141 is fitted into the engagement recess 143. Similarly, by fitting the other end of the holding member 141 into the engagement recess 143 of the other support member 142, the holding member 141 is attached to the lower housing section 32. It is preferable that the fixing member 144 be detachably attached to the support member 142 using a bolt or the like.

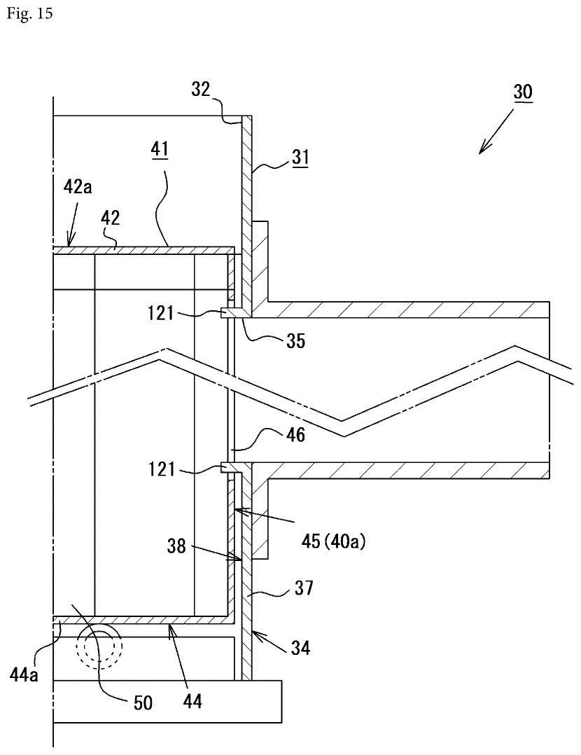

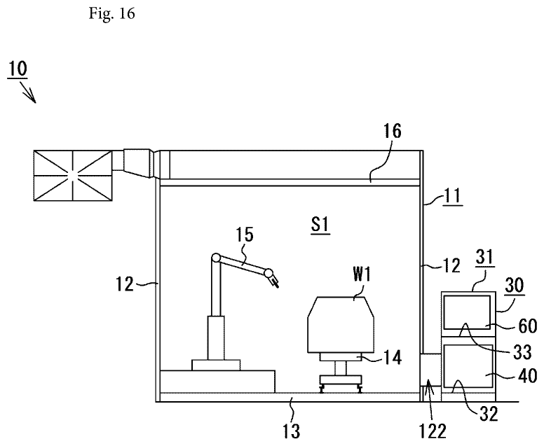

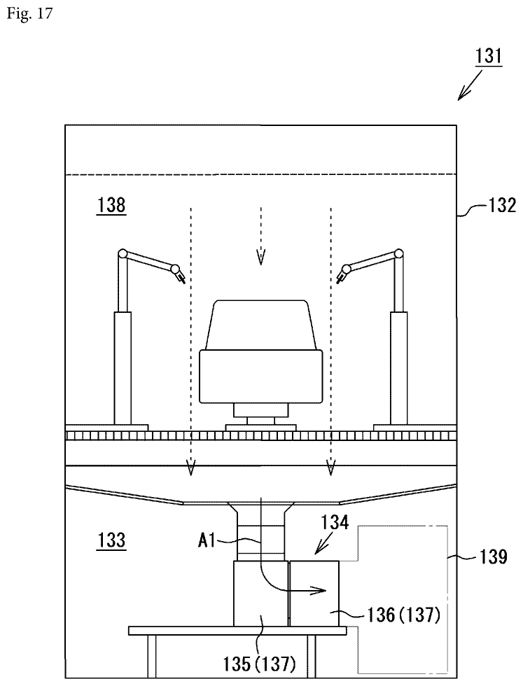

In addition, as shown in FIG. 14, the support member 92 may be replaced with a support member 145 provided with an engagement recess 146 that opens at a front surface 145a and a side surface 145b (the left side surface in FIG. 14). A projection 147 that protrudes downward is provided at the opening of the engagement recess 146. When one end of the holding member 141 is pressed from the left side to the right side of the support member 145, the projection 147 is pressed upward by the holding member 141, elastically deforms, and then returns to its original position, whereby one end of the holding member 141 is fitted into the engagement recess 146. Similarly, by fitting the other end of the holding member 141 into the engagement recess 146 of the other support member 145, the holding member 141 is attached to the lower housing section 32.
In the above embodiment, the amount of paint mist accumulated in the corrugated cardboard filter 40 is detected by measuring the weight of the corrugated cardboard filter 40 with a weighing device provided in the paint mist removal device 30. However, the amount of paint mist may alternatively be estimated based on the operating time of the corrugated cardboard filter 40, the number of workpieces W1 produced, or the air volume of the booth air A2 that has passed through the corrugated cardboard filter 40.
In the above embodiment, the inner surface 38 of the side wall 37 of the filter housing body 31, in which the inlet 35 is provided, was in surface contact with the air inlet surface 40a of the corrugated cardboard filter 40 accommodated in the lower housing section 32. However, as shown in FIG. 15, a rib 121 that can be pressed against the air inlet surface 40a of the corrugated cardboard filter 40 may be provided on the inner surface 38 of the side wall 37 so as to surround the inlet 35. The rib 121 is inserted into the filter body 41 through the inlet 46 and is disposed apart from the opening edge of the inlet 46.
In the above embodiment, the air transfer passage 21 is formed in the booth underfloor space S2. However, as shown in FIG. 16, the air transfer passage 122 may be installed at a position offset in the width direction of the coating line 14, avoiding the booth space S1—specifically, on the side of the side wall 12 of the coating booth 11 (on the right side in FIG. 16). The paint mist removal device 30 is installed at a position offset in the width direction of the coating line 14, avoiding the booth space S1, at the same height as the floor portion 13. In this way, the overall height of the coating booth 11 can be reduced.

In the above embodiment, a plurality of paint mist removal devices 30 may be installed along the longitudinal direction of the coating line 14 (i.e., the conveyance direction of the workpiece W1). By doing so, a large amount of booth air A2 can be processed.

In the above embodiment, an automobile body has been illustrated as an example of the workpiece W1 coated in the coating booth 11, but the invention is not limited thereto. For example, the workpiece may be an automotive interior component, such as an instrument panel, console box, or armrest, or an automotive exterior component, such as a bumper or aerodynamic attachment (e.g., a spoiler). The workpiece W1 may also be a component other than an automotive part.

Next, in addition to the technical concept described in the above aspects of the present invention, further technical concepts understood from the embodiment described above are listed below.
(1) The paint mist removal device according to any one of the first to seventh aspects of the present invention, wherein a guide member for guiding the booth air discharged from the primary filter to the secondary filter is not provided between the primary filter and the secondary filter.
(2) The paint mist removal device according to any one of the first to seventh aspects of the present invention, wherein the primary filter is formed in a box shape mainly of a combustible material.
(3) The paint mist removal device according to the seventh aspect of the present invention, wherein a tapered surface inclined with respect to the inner surface is provided at an end portion of the guide member on the side of the openable and closable door. According to this configuration, when the primary filter is accommodated in the lower housing section, it is possible to prevent the primary filter from being damaged due to the end portion of the guide member on the side of the openable and closable door catching on the primary filter.
(4) The paint mist removal device according to any one of the first to seventh aspects of the present invention, wherein a plurality of rollers that rotatably support the primary filter from below are provided at a bottom portion of the lower housing section. According to this configuration, the work efficiency in replacing the primary filter can be improved.
(5) The paint mist removal device according to any one of the first to seventh aspects of the present invention, wherein a common openable and closable door for inserting and removing the primary filter with respect to the lower housing section and inserting and removing the secondary filter with respect to the upper housing section is provided on a side surface of the filter housing body different from the side surface in which the inlet is provided. According to this configuration, it is not necessary to enter the filter housing body to replace the primary or secondary filter, and it is also unnecessary to open multiple doors.
(6) The paint mist removal device according to the technical concept (5), wherein a primary filter contact portion that can come into contact with the primary filter accommodated in the lower housing section is provided at a position on an inner surface of the openable and closable door facing the primary filter.
(7) The paint mist removal device according to the technical concept (5), wherein a secondary filter contact portion that can come into contact with the secondary filter accommodated in the upper housing section is provided at a position on an inner surface of the openable and closable door facing the secondary filter.
(8) The paint mist removal device according to any one of the first to seventh aspects of the present invention, wherein the coating booth performs coating while conveying a coated object along the longitudinal direction of a coating line, and a plurality of the paint mist removal devices are installed along the longitudinal direction of the coating line.

### DESCRIPTION OF REFERENCE NUMERALS

11: coating booth
30: paint mist removal device
31: filter housing body
32: lower housing section
32a: inner surface of lower housing section
33: upper housing section
34: side surface of filter housing body
35: inlet
36: outlet
37: side wall provided with inlet
38: inner surface of side wall provided with inlet
40: corrugated cardboard filter serving as primary filter
40a: air intake surface of primary filter
41: filter body
42: upper lid portion
42a: upper surface of upper lid portion
43: upper surface of primary filter (filter body)
45: side surface of primary filter (filter body)
46: inlet
47: outlet
56: guide member
60: secondary filter
91, 141: holding member
121: rib

1. A paint mist removal device that removes paint mist contained in booth air discharged from a paint booth by passing the booth air through a plurality of filters, comprising:
a filter housing body including:
a lower housing section configured to allow insertion and removal of a primary filter that is formed into a box shape mainly from a combustible material and that takes in the booth air from a side surface and discharges the booth air from an upper surface; and
an upper housing section disposed adjacent to an upper side of the lower housing section and configured to allow insertion and removal of a plurality of secondary filters arranged in an inverted V-shaped configuration;
wherein an inlet for introducing the booth air into the primary filter in the lower housing section is provided on a side surface of the filter housing body,
and an outlet for discharging the booth air from the secondary filters in the upper housing section is provided, in the filter housing body, at a position higher than the inlet.

2. The paint mist removal device according to claim 1, wherein a holding-down member configured to come into contact with an upper surface of the primary filter is provided on an upper portion of an inner surface of the lower housing section.

3. The paint mist removal device according to claim 2, wherein the primary filter includes a filter body having an inlet on a side surface and an outlet on an upper surface, and an upper lid portion that covers the upper surface of the filter body except for the outlet, and wherein the holding member is provided at a position where it can come into contact with an upper surface of the upper lid portion.

4. The paint mist removal device according to claim 3, wherein the holding member is provided detachably with respect to the lower housing section.

5. The paint mist removal device according to claim 4, wherein an inner surface of a side wall of the filter housing body in which the inlet is provided is in surface contact with an air intake surface of the primary filter accommodated in the lower housing section.

6. The paint mist removal device according to claim 4, wherein a rib projecting toward the primary filter accommodated in the lower housing section is provided on an inner surface of a side wall of the filter housing body in which the inlet is provided, so as to surround the inlet.

7. The paint mist removal device according to claim 4, wherein a guide member projecting from an inner surface of the lower housing section and extending along an insertion/removal direction of the primary filter is provided.
